(19) United States
(12) Patent Application Publication
(10) Pub. No.: US 2009/0189739 A1
(43) Pub. Date: Jul. 30, 2009

(54) PASSIVE VOICE ENABLED RFID DEVICES

(75) Inventor: Ray Wang, McLean, VA (US)

Correspondence Address: Lesavich High-Tech Law Group, P.C.;Suite 325, 39 S. LaSalle Street, Chicago, IL, 60603, US

(73) Assignee: Mobitrum Corporation, Silver Spring, MD (US)

(21) Appl. No.: 12/358,445

(22) Filed: Jan. 23, 2009

Related U.S. Application Data
(60) Provisional application No. 61/062,470, filed on Jan. 25, 2008.
(60) Provisional application No. 61/060,641, filed on Jun. 11, 2008.
(60) Provisional application No. 61/061,060, filed on Jun. 12, 2008.

(51) Int. Cl. H04Q 5/22; G10L 17/00

(52) U.S. Cl. 340/10.1; 704/246

(57) ABSTRACT

Passive voice enabled RFID devices. The passive voice enabled RFID devices include a power harvesting circuit that converts natural and artificial energy sources to voltage and current to power the device, thus, the device does not require a battery. It provides a voice capable RFID device with a power harvesting circuit that is powered by harvesting energy from various artificial or energy sources and/or natural energy sources such as: voice signals, other electromagnetic waves, sun light, vibrations, RF noise, etc. and used voice signals received to uniquely identify a generator of the voice signals or other sound signals.

### CROSS REFERENCES TO RELATED APPLICATIONS

This application claims priority to U.S. Provisional Patent Application 61/062,470, filed Jan. 25, 2008, and U.S. Provisional Patent Application 61/060,641, filed Jun. 11, 2008, the contents of both of which are incorporated by reference.

### U.S. GOVERNMENT RIGHTS

This invention was made, in part or in whole, with U.S. Government support from SBIR STTR Proposal Number 08-1 O2.02-9981 SSC, solicited by NASA. The U.S. Government may have certain rights in this invention.

### FIELD OF THE INVENTION

This invention relates to wireless networks. More specifically, it relates to passive voice enabled radio frequency identifier (RFID) network devices powered by converting electromagnetic energy to electrical voltage and current.

### BACKGROUND OF THE INVENTION

Radio-Frequency IDentification (RFID) is a technology providing automatic identification of objects, relying on, storing and remotely retrieving data using devices called RFID tags or transponders.

An RFID tag is an object that can be applied to or incorporated into a product, animal, or person for the purpose of identification using radio waves. Some tags can be read from several meters away and beyond the line of sight of the reader.

RFID tags come in three general varieties: passive, active, or semi-passive (also known as battery-assisted). Passive tags require no internal power source, thus being pure passive devices (they are only active when a reader is nearby to power them), whereas semi-passive and active tags require a power source, usually a small battery.

Recent industry standardization activities from the International Telecommunications Union-Telecommunication Standardization Sector (ITU), ITU-T (www.itu.int/ITU-T/worksem/rfid/program.html) and Institute of Electrical and Electronic Engineers (IEEE), IEEE 1451.7 (www.sensorsportal.com/HTML/standard_7.htm) subcommittee in defining communication methods and data formats for transducers (sensors and actuators) communicating with RFID tags indicated an emerging trend of combining RFID into sensors and/or sensor enhanced RFID tags to maximize the use of a wide variety of applications for detection, identification and tracking purposes.

RFID provides the means of tracking and identifying sensing objects and sensors provide information about the condition of the objects. The combination of these two technologies creates great opportunities to provide specialized sensors such as Data, Information and Knowledge (DIaK) sensors and sensor tracking extended services as part of capabilities offered by Integrated Systems Health Management (ISHM).

This trend has significant impact on advanced ground testing methods based on smart sensor technologies that are crucial to the development, qualification, and flight certification many complex technologies such defense technologies, rockets engines, etc. The ability to quickly and efficiently perform ground system certification greatly impacts all space programs.

There are a number of problems associated with combining technologies into RFID tags. One problem is that combination RFID tags and sensors are governed electromagnetic principles. Electrical circuits need a power source such as a battery or need to be capable of generating continual power for a device.

Another problem is that to communicate, RFID tags respond to queries generating signals that must not create interference with RFID readers, as arriving RF signals can be very weak and need to be distinguished.

Another problem is that RFID tags and smart sensors need to be capable of communicating with each other at any time without being compromised by interruption from power shortage either passively induced or actively on battery.

Another problem with RFID tags is that they do not have the ability to process voice information. Voice information typically requires significant continual power.

For example, U.S. Pat. No. 7,348,884 that issued to Higham entitled “RFID cabinet,” teaches An RFID for cabinet for monitoring items having an RFID tag includes a cabinet having at least one locking front door. An RFID detector is used for monitoring each item placed within the cabinet and is located within the interior of the cabinet. A computer is coupled to the RFID cabinet and controls opening and closing of the front door and is configured to receive an input that identifies the user. In this way, the computer is configured to periodically record data read from the RFID tags by the RFID detector.

U.S. Pat. No. 7,383,188 that issued to Sacks, et al., “Object loading system and method,” teaches “The invention is a method for objects selection at a location comprising the steps of using a mobile computer having a bar code reader, a display, an audio output device, an audio input device, a tactile input device, text to speech software, a voice recognition software, objects selection applications software, and radio frequency identification (RFID) reader, wherein said mobile computer is adapted for communication between an order systems server and a user and the order systems server is adapted for communication between the mobile computer and at least one external computer system.”

U.S. Pat. No. 7,143,041, that issued to Sacks, et al. entitled “Method for object selection,” teaches “The invention is a method for objects selection at a location comprising the steps of using a mobile computer having a bar code reader, a display, an audio output device, an audio input device, a tactile input device, text to speech software, a voice recognition software, objects selection applications software, and radio frequency identification (RFID) reader, wherein said mobile computer is adapted for communication between an order systems server and a user and the order systems server is adapted for communication between the mobile computer and at least one external computer system.”

U.S. Pat. No. 7,113,088, (US20040089709A1) that issued to Frick, et al. entitled “RFID activated information kiosk,” teaches “An information kiosk including a display, such as, for example, a touch screen, and having access to situational information is integrated with a radio frequency identification (RFID) sensor. The RFID sensor reads the RFID tag of a user, accesses user information corresponding to the RFID tag, and customizes an interface to the user based on the user information and the situational information. The interface is then output to the user using the display of the information kiosk. The information kiosk may communicate with a private branch exchange (PBX) switch to permit use of a contact information center (CIC) or a voice portal. The user information may be stored as a user profile in a Customer Relationship Management (CRM) system, accessed by the information kiosk. By combining the user information with event or location information stored in the information kiosk, the information kiosk presents customized information to each user, including maps, directions, and recommended sites or events.”

U.S. Pat. No. 7,023,341 that issued to Stilp entitled “RFID reader for a security network,” teaches “An RFID reader for use in a security network based upon RFID techniques. The RFID reader can use wireless communications to communicate with RFID transponders and other devices in the security network. The RFID reader of the security network can be provided with multiple modulation techniques, multiple antennas, and the capability to vary its power level and carrier frequency. The RFID reader can transmit RF energy useful for detecting motion or for charging the batteries in RFID transponders. The RFID reader can contain an audio transducer, a camera, or various environmental sensors to detect parameters such as smoke, temperature, and water, among others. The program code of the RFID reader can be updated. A master controller within the security network can control operations within the RFID reader.”

U.S. Published Patent Application 20070115940A1, published by Kamen et al. entitled “Method and system for multi-level secure personal profile management and access control to the enterprise multi-modal communication environment in heterogeneous convergent communication networks” teaches “A method and apparatus, in accordance with an embodiment of the present invention, is presented for securely accessing a voice-enabled communication terminal using Internet Protocol by performing physical authentication, performing biometric authentication, performing logical authentication, performing confirmation of a user and upon successful confirmation of the user, allowing access to the communication terminal.

However, none of these solutions solve all of the problems associated with voice activated RFID tags.

Thus, it is desirable to provide passive RFID devices activated with voice information and capable of processing voice information.

### SUMMARY OF THE INVENTION

In accordance with preferred embodiments of the present invention, some of the problems associated with RFID devices are overcome.

Voice enabled RFID network devices are presented. The Voice enabled RFID network devices include a power harvesting circuit that converts near by natural energy sources to voltage and current to power the device. Thus, this voice enable passive RFID network does not require a battery. It provides a voice capable RFID network with a power harvesting circuit that is powered by harvesting energy from various artificial or energy sources and/or natural energy sources such as: voice signals, other electromagnetic waves, sun light, vibrations, RF noise, etc. This passively powered energy harvesting technique can also be applied to cellular devices, MP3 devices, smart phones, netbook and other types of network devices or electrical devices that typically require and use battery power for producing direct current (DC).

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram of an exemplary communications network;

FIG. 2 is a block diagram illustrating a passive voice enabled RFID network device;

FIG. 3 is a block diagram illustrating additional details of a power generating circuit for the passive voice enabled RFID network device;

FIG. 4 is a block diagram illustrating additional details of the power generating circuit;

FIG. 5 is a flow diagram illustrating a method for using a passive voice enabled RFID network device; and

FIG. 6 is a block diagram of an exemplary communications network using passive voice enabled RFID network devices.

### DETAILED DESCRIPTION OF THE INVENTION

### Exemplary Communications System

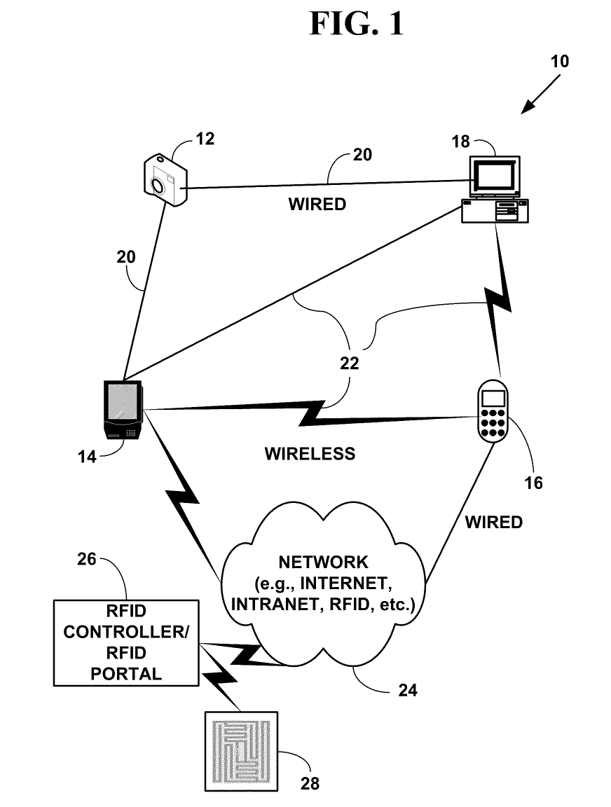

FIG. 1 is a block diagram of an exemplary communications system 10. In one embodiment, the communications network includes a mesh network with a local area network (LAN) that employs one of two connection arrangements, “full mesh topology” or “partial mesh topology.” In the full mesh topology, plural nodes 12, 14, 16, 18 are connected directly to each of the others. In the partial mesh topology some nodes are connected to all the others, but some of the nodes are connected only to those other nodes (e.g., those with which they exchange the most data, etc.). The connections can be wired 20 or wireless 22. A mesh network is reliable and offers redundancy. If one node can no longer operate, all the rest can still communicate with each other, directly or through one or more intermediate nodes. Mesh networks work well when the nodes are located at scattered points that do not lie near a common line.

The plural nodes include 12, 14, 16, 18 but are not limited to, network devices including sensors, Remote Frequency Identifier (RFID) devices, Bluetooth devices or Zigbee, multimedia capable desktop and laptop computers, facsimile machines, mobile phones, non-mobile phones, Internet phones, Internet appliances, personal digital/data assistants (PDA), two-way pagers, digital cameras, televisions and other types of network devices. The plural network devices include one or more of a wired interface and/or a wireless interface used to connect to a mesh network to provide voice, video and data communications.

Selected ones of the plural nodes 12-18 are connected to a communications network 24. The communications network 24 includes, but is not limited to, a mesh network, a partial mesh network, an RFID network, the Internet, an intranet, a wired Local Area Network (LAN), a wireless LAN (WiLAN), a wireless personal area network (WPAN), wireless Wide Area Network (WAN), a wireless Metropolitan Area Network (MAN), a Public Switched Telephone Network (PSTN) and other types of wireless and wired communications networks 24.

The communications network 24 may include one or more gateways, routers, bridges, switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments. Switches typically operate at the data link layer and sometimes the network layer and therefore support virtually any packet protocol.

The plural nodes 12-18 may be connected to one or more server network devices (not illustrated) include one or more associated databases. The one or more server devices are in communication with the plural nodes via the communications network 24. The one or more server network devices include, but are not limited to, World Wide Web servers, Internet servers, file servers, other types of electronic information servers, and other types of server network devices (e.g., edge servers, firewalls, routers, gateways, etc.). The one or more server network devices 30 may be included inside a building or outside a building.

The system 10 further includes an RFID controller/RFID portal 26 and plural RFID devices 28 (only one of which is illustrated). The RFID controller/RFID portal 26 stores and remotely retrieves data using devices called RFID transponders 28.

Preferred embodiments of the present invention include network devices and interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum. However, network devices based on other standards could also be used. IEEE standards can be found on the World Wide Web at the Universal Resource Locator (URL) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” Bluetooth Forum documents can be found at the URL “www.bluetooth.com.” WAP Forum documents can be found at the URL “www.wapforum.org.” ADSL Forum documents can be found at the URL “www.adsl.com.”

An operating environment for devices and interfaces of the present invention include a processing system with one or more high speed Central Processing Unit(s) (CPU) and a memory. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU executed” or “processor executed.”

It will be appreciated that acts and symbolically represented operations or instructions include the manipulation of electrical signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (RAM)) or non-volatile (e.g., Read-Only Memory (ROM)) mass storage system readable by the CPU. The computer readable medium includes cooperating or interconnected computer readable medium, which exist exclusively on the processing system or be distributed among multiple interconnected processing systems that may be local or remote to the processing system.

As is known in the art, the Open Systems Interconnection (OSI) reference model is a layered architecture that standardizes levels of service and types of interaction for computers exchanging information through a communications network. The OSI reference model separates network device-to-network device communications into seven protocol layers, or levels, each building-and relying--upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

In one embodiment of the present invention, the wireless interfaces include but are not limited to, an IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces. In another embodiment of the present invention, the wireless sensor device may include an integral or separate Bluetooth and/or infra data association (IrDA) module for wireless Bluetooth or wireless infrared communications. (not illustrated). However, the present invention is not limited to such an embodiment and other 802.11xx and other types of wireless interfaces can also be used.

As is known in the art, an 802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11X interfaces can also be used and the present invention is not limited to the 802.11 protocols defined. The IEEE 802.11a, 802.11b and 802.11g standards are incorporated herein by reference.

As is known in the art, Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL “www.weca.net.”

As is known in the art, 802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, fully handshaked protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference. More information on 802.15.4 and ZigBee can be found at the URL “www.ieee802.org” and “www.zigbee.org” respectively.

As is known in the art, WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and TI/El for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.” ETSI HIPERMAN can be used to provide a WLP.

### Security and Encryption

Devices and interfaces of the present invention may include security and encryption for secure communications. Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES). More information on NIST AES can be found at the URL “www.nist.gov/aes.”

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

However, the present invention is not limited to the security or encryption techniques described and other security or encryption techniques can also be used.

As is known in the art, IP is an addressing protocol designed to route traffic within a network or between networks. For more information on IP see IETF RFC-791 incorporated herein by reference.

TCP provides a connection-oriented, end-to-end reliable protocol designed to fit into a layered hierarchy of protocols that support multi-network applications. For more information on TCP see RFC-793, incorporated herein by reference.

UDP provides a connectionless mode of communications with datagrams in an interconnected set of networks. For more information on UDP see ITEF RFC-768 incorporated herein by reference.

As is known in the art, the HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

As is known in the art, the SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security method are negotiated between the source and destination at the start of establishing a protocol session. The SSL 2.0 protocol specification, by Kipp E. B. Hickman, 1995 is incorporated herein by reference. More information on SSL is available at the URL See “netscape.com/eng/security/SSL_{—}2.html.”

As is known in the art, Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products.

### Passive Voice Enabled RFID Network Device

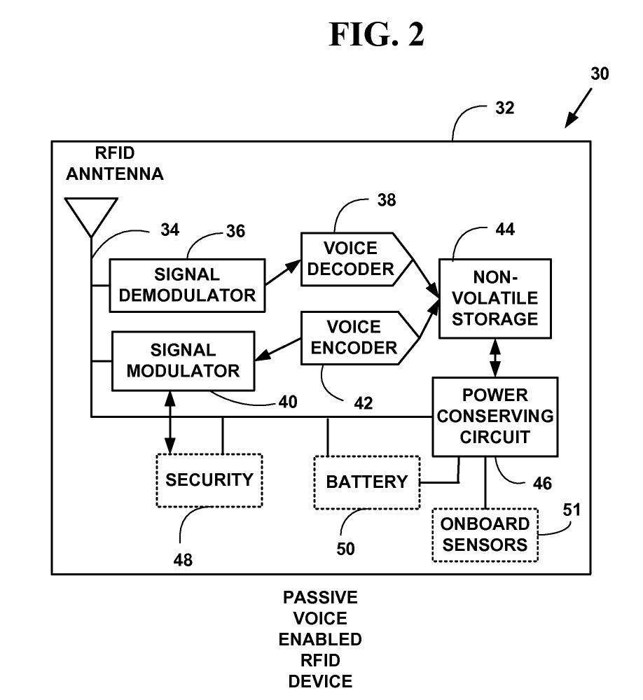

FIG. 2 is a block diagram 30 illustrating a passive voice enabled RFID network device 32. The device 32 is a transceiver and includes a radio frequency (RF) antenna 34, a signal demodulator 36, a voice decoder 38, a signal modulator 40, an optional voice encoder 42, non-volatile storage 44, a power generating circuit 46, an optional security module 48 and an optional battery 50. Optional onboard sensors 51 may also be included in the device 32. However, the present invention is not limited to these components, and more fewer or other components can also be used to practice the invention.

The power generating circuit 46 includes a power harvesting circuit that provides power to the device by harvesting energy from natural or artificial energy sources received on the RF antenna 34. The power harvesting circuit 34 provides power to the device without the need for an internal power source. A voice identification application stored in the non-volatile storage 44 is used to uniquely identify an entity producing the voice signals received on the RF antenna 34.

As is known in the art, human voice information consists of sounds made by a human being using human vocal folds. The vocal folds, in combination with articulators, are capable of producing highly intricate arrays of sounds.

A “voice frequency (VF)” or “voice band” is one of the frequencies, within part of the audio range that is used for the transmission of human speech. In telephony, the typical usable voice frequency band ranges from approximately 300 Hz to 3400 Hz.

It is for this reason that the ultra low frequency band of the electromagnetic spectrum between 300 and 3000 Hz is also referred to as voice frequency (despite the fact that this is electromagnetic energy, not acoustic energy). The bandwidth allocated for a single voice-frequency transmission channel is usually 4 kHz, including guard bands, allowing a sampling rate of 8 kHz to be used as the basis of the pulse code modulation (PCM) and other modulation schemes used on voice coders/decoders (codecs) for the PSTN and other voice networks including Voice-over-Internet Protocol (IP) networks.

As is known in the art, VoIP is a set of facilities for managing the delivery of voice information using IP packets. In general, VoIP is used to send voice information in digital form in discrete data packets (i.e., IP packets) over data networks rather than using traditional circuit-switched protocols used on the PSTN. VoIP is used on both wireless and wired data networks.

VoIP typically comprises several applications (e.g., Session Initiation Protocol (SIP), Service Location Protocol (SLP), H.323, H.324, Domain Name System (DNS), Authentication Authorization and Accounting (AAA), codecs (G.7xx), etc.) that convert a voice signal into a stream of packets (e.g., IP packets) on a packet network and back again. VoIP allows voice signals to travel over a stream of data packets over a communications network.

The voice speech of a typical adult male has fundamental frequency of from 85 to 155 Hz, and that of a typical adult female from 165 to 255 Hz. Thus, the fundamental frequency of most human speech falls below the bottom of the “voice frequency” band as defined above. However, due the characteristics of the voice signals, enough of a harmonic series is present in the missing voice signal fundamentals to recreate the fundamental tones of human male and female speech for use in telephony.

Voice information also includes sound information generated by non-humans such as animals, and sound information generated artificially by electronically circuitry. As is known in the art, sound is vibrational energy transmitted through a solid, liquid, or gas.

In one embodiment, the passive voice enabled RFID network device 32 is a passive voice enabled RFID tag. In another embodiment, the passive voice enabled RFID network device 32 is a passive voice enable RFID sensor. In another embodiment, the passive voice enable RFID network device 32 is a passive voice enabled RFID biometric tag.

As is known in the art, an “RFID tag” is an object that can be applied to or incorporated into a product, animal, or person for the purpose of identification and/or tracking using RF signals.

As is known in the art, an “RFID sensor” is a device that measures a physical quantity and converts it into an RF signal which can be read by an observer or by an instrument (e.g., RFID controller/RFID portal 26, etc.)

As is known in the art, a “biometric” is method for uniquely recognizing humans or non-human entities based upon one or more intrinsic physical or behavioral traits. Thus, an RFID biometric tag is an object that can be applied to or incorporated on or into a human or animal for the purpose of identification.

There are generally two types of RFID devices: active RFID devices, which include a battery, and passive RFID devices, which have no battery. The device 32 is a passive RFID device and does not require a power source such as a battery.

In one embodiment, the radio frequency (RF) antenna 34 includes a WPAN wireless personal area network (WPAN) interface antenna. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, two-way pager, etc.). However, the present invention is not limited to a WPAN antenna and other RF antennas can also be used to practice the invention.

Typically, a wireless personal area network uses some technology that permits communication only within about ten meters. One such technology is “Bluetooth.” Another such technology is “Zigbee.”

A key concept in WPAN technology is known as “plugging in.” In the ideal scenario, when any two WPAN-equipped devices come into close proximity (within several meters of each other) or within a few kilometers of a central server (not illustrated), they can communicate via wireless communications as if connected by a cable. WPAN devices can also lock out other devices selectively, preventing needless interference or unauthorized access to secure information.

In one embodiment of the present invention, the RF antenna 34 accepts wireless signals, including, but are not limited to, IEEE 802.11a, 802.11b, 802.11g, 802.11n, 802.15.4 (ZigBee), 802.16a, 802.16g, “Wireless Fidelity” (Wi-Fi), “Worldwide Interoperability for Microwave Access” (WiMAX), ETSI High Performance Radio Metropolitan Area Network (HIPERMAN) “RF Home,” Bluetooth or other types of wireless signals. However, the present invention is not limited to such RF antennas and other types of RF antennas can also be used.

In another embodiment of the present invention, the RF antenna 34 includes a wireless sensor device that comprises an integral or separate Bluetooth and/or infra data association (IrDA) module for wireless Bluetooth or wireless infrared communications.

In one embodiment, the RF antenna 34 includes a baseband transceiver. As is known in the art, a “baseband” transceiver is a transceiver in which information is carried in digital form in one or more channels on a transmission medium. A baseband includes any frequency band on which information is superimposed, whether or not a frequency band is multiplexed and on which digital information can be sent on sub-bands.

In one embodiment, signal demodulator 36 and signal modulator 40 includes Complementary Code Keying (CCK). As is known in the art, CCK is a modulation scheme used with wireless networks (WLANs) that employ the IEEE 802.11b specification. A complementary code includes a pair of finite bit sequences of equal length, such that a number of pairs of identical elements (e.g., one or zero) with any given separation in one sequence are equal to a number of pairs of unlike elements having the same separation in the other sequence.

In one embodiment, signal demodulator 36 and signal modulator 40 includes differential quadrature phase shift keying (DQPSK). DQPSK modulates using differential quaternary phase shift keying. The output is a baseband representation of the modulated signal.

In one embodiment signal demodulator 36 and signal modulator 40 includes differential binary phase shift keying (DBPSK). DBPSK modulates using the differential binary phase shift keying. The output is a baseband representation of the modulated signal.

In one embodiment, signal demodulator 36 and signal modulator 40 includes Orthogonal frequency division multiplexing (OFDM). OFDM is also called discrete multi-tone modulation (DMT) and is a transmission technique based upon the idea of frequency-division multiplexing (FDM) where multiple signals are sent out at different frequencies. OFDM uses a composite of narrow channel bands to enhance its performance in high frequency bands (such as 5.x GHz) in urban and rural applications where building clutter and foliage can negatively impact the propagation of radio waves for wireless devices.

In one embodiment, signal demodulator 36 and signal modulator 40 includes Carrier Sense Multiple Access/Collision Avoidance (CSMA/CA). CSMA/CA is a data-link layer protocol used in the data-link chip for carrier transmission in 802.11xx networks. CSMA/CA acts to prevent collisions before they happen.

However, other signal modulators and signal demodulators could also be used and the present invention is not limited to such signal modulators/demodulators.

In one embodiment, the audio codecs used in the voice decoder 38, and optional voice encoder 42 are compliant ITU-T G.711, G.722, G.723, G.728 and G.729 standards, the contents of which are incorporated herein by reference. Global System for Mobile Communications (GSM) codecs can also be used.

As is known in the art, GSM is a digital cellular telephone technology widely used throughout Europe, in Australia, India, Africa, Asia, and the Middle East, and growing in use in the United States. The ITU-T GSM codec standards are incorporated herein by reference. However, other audio codecs could also be used and the present invention is not limited to such audio codecs.

The non-volatile storage 44 includes non-volatile memory such as flash memory, EEPROM, etc. However, the device 32 is not limited to such non-volatile storage and other types of non-volatile storage can also be used to practice the invention.

A voice identification application stored in the non-volatile storage 44 uniquely identifies a human entity or non-human entity producing the voice signals received on the RF antenna 34. The passive voice enabled RFID network device 32 provides “speaker recognition” based on voice information or other sound information decoded by the voice decoder codec 38. “Speaker recognition” is a validating a speaker's claimed identity using characteristics extracted from the speaker's voice.

There is a difference between “speaker recognition ” (i.e., recognizing who is speaking) and “speech recognition ” (i.e., recognizing what is being said). These two terms are frequently confused, as is “voice recognition.”

“Voice recognition” is a synonym for “speaker recognition,” and thus is not speech recognition. However, in another embodiment, the device 32 also can be programmed to perform speech recognition by storing and executing the appropriate applications and identification information in non-volatile storage 44.

In another embodiment of the invention, the “speaker recognition” includes sound recognition of animal sounds, and other unique artificial sounds that be generated by electronic circuitry.

The power generating circuit 42 includes a power harvesting circuit that converts artificial or natural energy sources to voltage and current to power the device 32 with Direct Current (DC) power. In another embodiment, the device is powered with analog current (AC) power provided by the power harvesting circuit. The artificial or natural energy sources include (but are not limited to) kinetic, thermal, gravitational, sound, light, chemical, nuclear and electromagnetic energy.

As is known in the art, kinetic energy is the energy due to the movement of an object. Thermal energy is energy derived from heat. Gravitational energy is energy derived from gravity. Sound energy is an energetic vibration transmitted through a solid, liquid, or gas. Light energy or visible light, is electromagnetic radiation of a wavelength that is visible to the human eye (about 400-700 nm), or up to 380-750 nm. In the broader field of physics, light is used to refer to electromagnetic radiation of all wavelengths, whether visible or not. Chemical energy is a net potential energy liberated or absorbed during the course of a chemical reaction. Nuclear energy is energy produced during a nuclear reaction.

As is known in the art, electromagnetic energy has an electric and magnetic field component which oscillate in phase perpendicular to each other and to the direction of energy propagation. Electromagnetic radiation is classified into types according to the frequency of the wave, these types include, for example, radio waves, microwaves, terahertz radiation, infrared radiation, visible light, ultraviolet radiation, X-rays, gamma rays, etc.

### Power Generating Circuit 42

One objective of the power generating circuit 42 is to produce enough direct current (DC) power to power at least a 16-bit (or larger) microcontroller and interact with external RFID sensors, RFID tags, other external sensors through a single RF antenna 34. Power requirements in the power generating circuit 42 are calculated from a “link budget.” The “link budget” is an amount of power that the device 32 needs to send and receive RF data across a RF wireless link in order that transmitted RF data can be successfully sent to and received on a RFID controller/RFID portal 26.

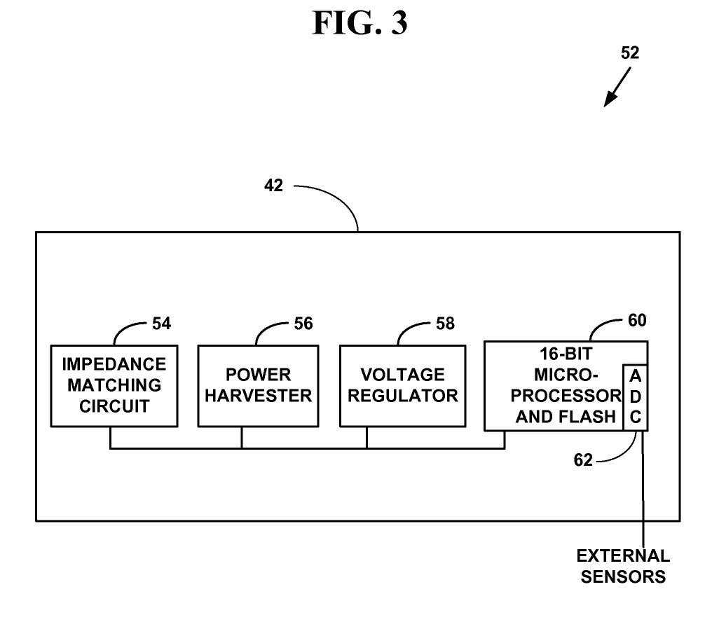

FIG. 3 is a block diagram 52 illustrating additional details of a power generating circuit 42. The power generating circuit 42 includes an impedance matching circuit 54, a power harvester circuit 56, a voltage regulator 58, a fully programmable 16-bit microcontroller (MCU) 60 with flash memory and one or more high-resolution analog-to-digital (ADC) converters 62. The ADC may be connected to one or more external sensors, such as biological, kinetic, thermal, gravitational, sound, light, etc.

However, the present invention is not limited to this configuration and more, fewer or other components can also be used in the power generating circuit 42 to practice the invention.

The antenna 34 is connected to the impedance matching circuit 54. As is known in the art, electrical impedance, or simply impedance, describes a measure of opposition to a sinusoidal alternating current (AC). Electrical impedance extends the concept of resistance to AC circuits, describing not only the relative amplitudes of the voltage and current, but also the relative phases.

The power harvester 56 rectifies incoming RF energy as AC signals into DC voltage to power the device 32. The demodulator 36 follows an envelope of an RF carrier wave to extract an incoming modulated data stream. This extracted base band waveform is read by the MCU 60 to receive downlink RF data from the reader. For uplink RF data, it is sent via the signal modulator 40, which functions by changing the antenna impedance. Any onboard sensors 51 or connection to external sensors are powered and measured by the MCU 60. For example, the onboard sensors and/or external sensors may include biological agent sensors (e.g., anthrax, etc.) or sensors for kinetic, thermal, gravitational, sound, light, chemical, nuclear or electromagnetic energy.

In order to calculate a link budget, the following parameters are considered: (1) How much RF power can the RFID controller/portal 26 transmit? (2) How much power does the device 32 receive relevant to the distance from a RFID controller/portal 26? (3) How much power does the device 32 need to turn on its pre-determined hardware capability? (4) How much power does the device 32 need for modulation and demodulation? And (5) How much power does the device need for voice decoding and/or optionally voice encoding? However, the present invention is not limited to these parameters and the link budget can also be calculated with more or fewer parameters.

In order to calculate a link budget between the RFID controller/RFID portal 26 and the device 32, three parameters are used: (1) transmit power; (2) path loss; and (3) power required at the received antenna on the RFID controller/RFID portal 26. However, the present invention is not limited to these parameters and more, fewer or other parameters can also be used to practice the invention.

In general, finding the “path loss” requires knowing the details of the RF antenna 34 operation. An omni-directional RF antenna is used that radiates essentially a non-directional pattern in an azimuth and a directional pattern in elevation plane.

However, the present invention is not limited to such an antenna and other types of directive antenna and/or multiple-input and multiple-output (MIMO) approaches can also be used to practice the invention.

Using an omni-directional antenna, a power density at a distance (d) is a ratio of the transmitted power P_{TX} to a sphere area. The power delivered to a received antenna P_{RX} can be determined as is illustrated in Equation (1):

P_{RX}=P_{TX}(effective aperture of the received antenna)/4Πd²×Antenna Gain (1)

wherein, the equation in Equation (1) is known as the Friis Transmission Equation.

Assuming a maximum transmitting power that is one Watt (W) allowed by U.S. Federal Communications Commission (FCC), the path loss between 900 MHz antennas with Additive White Gaussian Noise (AWGN) considered is estimated using Equation (2):

10 log(1W/1 mW)−10 log(P_{RX})≈30 dBm−(−1.6 dBm)≈32 dB (2)

However, the present invention is not limited to these calculations or a one Watt maximum and other parameters can be used to practice the invention.

This maximizes the received power (>0.7 mW or −1.6 dBm) in order to turn on the power harvester circuit 42 in a receiver located from afar-field of the transmitting antenna 34.

In one specific exemplary embodiment, this design is sufficient to harvest enough power to run a battery-free voice enabled RFID device 32 using a 16-bit RISC microcontroller MCU 60, designated as MSP430, from Texas Instruments. Its peripherals and flexible clock system are combined by using a Von-Neumann common memory address bus (MAB) and memory data bus (MDB) partnering a modern CPU with modular memory-mapped analog and digital peripherals.

One reason for choosing a device such as the MSP430 for this specific exemplary design is because it was designed specifically for ultra-low-power applications. However, the present invention is not limited to the devices described and other devices can also be used to practice the invention.

A flexible clocking system, multiple operating modes and zero-power always on brownout reset (BOR) are implemented to reduce power consumption. The MSP430 BOR function is always active, even in all low-power modes to ensure the most reliable performance possible. The CPU has multiple operating modes at the power consumptions illustrated in Table 1.

TABLE 1

0.1-μA power down and 0.8-μA standbys
250-μA/MIPS @ 3 V
1.8-V to 3.6-V operation

In other words, the power harvesting circuit 42 is designed to support a minimum 1.8-V to power a voice enable RFID device 32 embedded with 16-bit microprocessor, flash memory, modulation and demodulation circuits 36, 40, voice decoder circuits 38 optional voice encoder 42 and external sensors such as used for biological agents, kinetic, thermal, gravitational, sound, light, chemical, nuclear and electromagnetic energy.

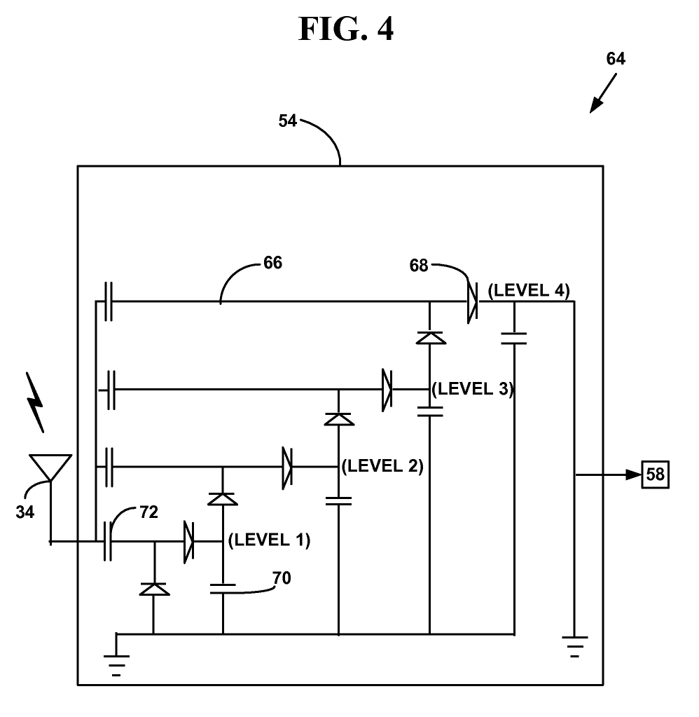

FIG. 4 is a block diagram 64 illustrating additional details of the power harvester circuit 56 used in the exemplary power generating circuit 42.

The power harvester circuit 56 includes an N-level charge pump 66 with a pre-determined number of diodes and capacitors configured in a pre-determined configuration.

In one specific exemplary embodiment the N-level charge pump 66 includes four levels, eight diodes and eight capacitors. However, the present invention is not limited to this embodiment and more or fewer levels, diodes and capacitors can also be used to practice the invention.

The charge pump 66 illustrated in FIG. 4 includes four levels with a pre-determined number of diodes 68 connected on layers in series so that a resulting output voltage is increased. A “voltage doubler” circuit is shown in each level. Sets of two diodes 68 are connected in series and oriented so that forward current flows from a ground potential to a positive terminal of an output voltage regulator 58. One or more capacitors 70 are connected in parallel with the diode in each layer stores a resulting charge to smooth the output voltage. A capacitor 72 nearest the antenna 34 prevents DC current from flowing between the antenna 34 and the diodes 68, but store charges and thus, permits high frequency current to flow.

When a RF input is negative and larger than the turn-on voltage, the first diode is on. Current flows from the ground through the diode, causing charge to accumulate on the input capacitor. At the negative peak, a voltage across the capacitor is the difference between the negative peak voltage and the voltage on the top of the diode.

When the RF input becomes positive, the first diode turns off and the second (output) diode turns on. The charge that was collected on the input capacitor travels through the output diode to the output capacitor. The peak voltage that can be achieved is double the result of the peak positive RF voltage subtracting the turn on voltage of the output diode.

Additional levels can also be added to the charge pump circuit 66. However, limitations exist on how many additional levels could be added to the charge pump circuit 66 to convert more DC power due to decreasing power-efficiency when extra turn-on voltage of the diodes is required. Hence, the power-efficiency vs. number of charge pump layers is one of the design considerations of the present invention.

Another design consideration before implementing the charge pump circuit 66 is to select an antenna and associated matching structures as needed to provide as high an output voltage as possible from a given incident electric field. A trade-off is also made between the use of circularly polarized antenna, sacrificing range, or the use of polarization-diverse antenna and adding cost and size to the antenna structure.

In one exemplary embodiment, a voltage charge pump circuitry 66 at the far-field is used to produce a minimum 1.8-V DC from UHF (900 MHz range) and 2.4 GHz RF energy sources. Equation (1) and (2) are used to derive the desired accuracy for the circuitry 66 based on these parameters. However, the present invention is not limited to these parameters and other parameters can also be used to practice the invention.

Unlike a common RFID approach, which harvests minimum power to turn on an IC chip, the device 32 operates at the far-field from a transmitting antenna and utilizes a multi layer charge pump circuit 66 to convert more DC power to operate a fully programmable microcontroller with flash memory and high-resolution analog-to-digital converters. The microcontroller firmware also implements portions of the Electronic Product Code (EPC) Class 1 Generation 1 protocol.

When queried, the device 32 communicates arbitrary sensor data by emulating an EPC tag within a transducer electronic data sheet (TEDS) to encode the desired sensor data. A required CRC (e.g., 16-bit CRC) is computed dynamically by the microcontroller 60. The device 23, which is a RF transmitter and functions equivalent to RFID reader, reports the received tag ID from IEEE 1451 TEDS to application software stored in non-volatile storage 44, 60, which can interpret the information included in the TEDS.

The programmability of the device 32 along with its implementation as a PCB allows for flexible integration of arbitrary low-power sensors. Furthermore, such passive voice enable RFID sensors 32 are also exclusively powered from the power harvester 56 resulting in a completely battery free device. The device 32 is a fully programmable and can operate using power transmitted from long-range UHF and/or 2.4 GHz devices and communicate arbitrary, multi-bit data in a single response packet

Additionally, energies from one or more of the following: (1) RF ISM band at 5 GHz, (2) vibrational energy; (3) RF noise sources near device 32; (4) animal sounds; and (5) repeating RF signals, are added into pump circuitry 66 using Equations (1) and (2). Thus, the device can be additional powered from these additional energy sources picked up on the antenna 34.

In one specific exemplary embodiment, the power harvesting circuit 56 is configured specifically for harvesting energy from license free ISM bands: 900 MHz to 2.4 GHz radio waves generated from the RFID controller/RFID portal 26 and for scavenged electromagnetic energy, vibrations and RF noise from open-air sources and provide the capability to harvest energy from nearby RF energy source in open air between 800 MHz to 2.4 GHz without depending on a RFID controller/RFID portal 26 to transmit any RF energy whatsoever to the device. However, the present invention is not limited to this configuration and other configurations using other energy sources can also be used to practice the invention.

Equation (1) teaches that the radiation power received at the device 32 is proportional to an effective aperture of the antenna 34 in relation to its efficiency and directive gain. Therefore, an advanced antenna beam forming technique (e.g., MIMO, etc.) is used to achieve a high-degree of DC power conversion.

As a result of the power generating circuit 42, the device 32 does not require a battery. It includes a passive voice capable RFID network device with a power harvesting circuit that is powered by harvesting energy from various artificial or energy sources and/or natural energy sources such as: voice signals, other electromagnetic waves, sun light, vibrations, RF noise, etc.

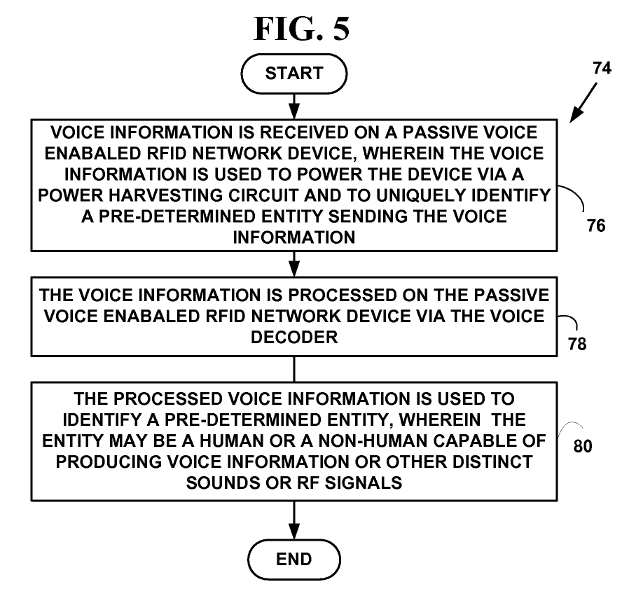

FIG. 5 is a flow diagram illustrating a Method 74 for using a passive voice enabled RFID voice network device. At Step 50, voice information is received on a passive voice enabled RFID network device. The voice information is used to power the device via a power harvesting circuit and to uniquely identify a pre-determined entity sending the voice information. At Step 52, the voice information is processed on the passive voice enabled RFID network device via the voice decoder. At Step 54, the processed voice information is also used to identify a pre-determined entity. The entity may be a human or a non-human capable of producing voice information or other distinct sounds or signals. Information about the pre-determined entity is stored in the non-volatile memory.

Method 74 is illustrated with an exemplary embodiment. However, the present invention is not limited to this exemplary embodiment and other embodiments may be use to practice the invention.

In such a specific exemplary embodiment at Step 50, voice information is received on a passive voice enabled RFID network device 32. The voice information is used to generate power in a power generating circuit 42 and is used to identify a pre-determined entity sending the voice information. Other types of natural and artificial energy is also used by the power generating circuit 42 to power the device 32.

At Step 52, the voice information is processed on the passive RFID tag via a voice decoder 38. In one embodiment, the processing includes comparing the processed voice information to voice information storage in non-volatile memory 44 or flash in MCU 60.

At Step 54, the processed voice information is also used to identify a pre-determined entity. In one embodiment, the device 32 is a voice enabled RFID tag used as a voice activated personal identification tag, a voice activated personal communicator, etc. Therefore, it provides the capabilities for voice-based identification, voice-based tracking, and voice-based communications.

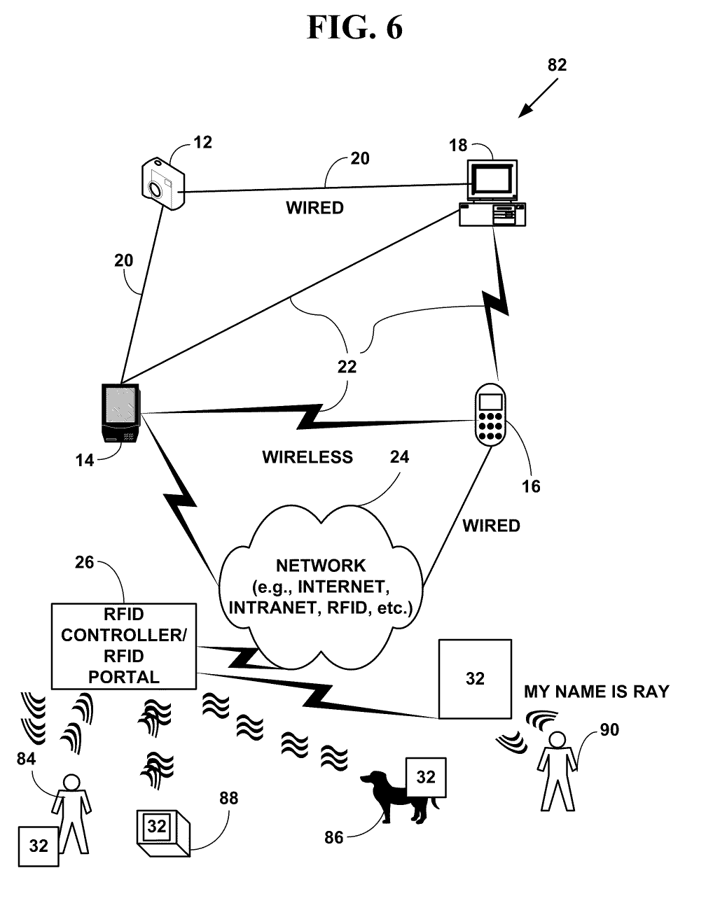

FIG. 6 is a block diagram 82 of an exemplary communications network using passive voice enabled RFID network devices 32.

In one embodiment, one or more voice and/sound identities of human 84 and non-human 86, 88 (e.g., animals, goods, etc.) are stored in the non-volatile storage 44, 60 on the device 32 to positively identify the human or non-human entity based on voice information or other sound information characteristics. In such an embodiment, the device is attached directly to the human 84 or non-human entity 86, 88. Communication is to/from the device 32 and/or to/from the RFID controller/RFID portal 26.

In the case of non-human entities such as animals 86, the voice information characteristics include sounds such as barking, growling, chirping, etc. The non-human entities can also includes packages 88 etc., with devices that generate a unique sound (or RF signal) that can be processed by voice decoder 38 and identified on the device 32.

In another embodiment, the device 32 may be attached to something (e.g., a wall, door, etc.) near the RFID controller/RFID portal 26. In such an embodiment, the human 90 (or animal or inanimate object such as a package, etc.) would speak (or broadcast, etc.) a pre-determined voice command (e.g., a sentence, phrase, name, etc.) to the device 32 and the device 32 would uniquely identify the human 90 to and between the RFID controller/RFID portal 26.

In another embodiment, the device 32 is an active RFID device that includes an optional battery 50 (or other DC power source).

In another embodiment, the device 32 includes a security module 48 using one or more of the security features described above for secure communications. The security module 48 can be used on the device 32 if the device 32 uses the power generating circuit 42 and/or the battery 50.

The device 32 may be used for unique identity identification via voice, biometrics, supply chain management, medical, for Data, Information and Knowledge (DIaK) sensors and sensor tracking extended services such as those used as part of capabilities offered by Integrated Systems Health Management (ISHM) and for other applications.

The architecture of a passively powered voice enabled RFID network device 32 brings a rich set of state-of the-art capabilities to support ISHM systems for sensing, processing, control, and distribution. Such devices 32 enable a mesh network, a mesh sensor network or other sensor network to significantly to increase capabilities for improved identification and tracking, data sharing, information dissemination, online data processing, automated feature extraction, data fusion, and parallel and distributed computing functions.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A passive voice enabled radio frequency identifier (RFID) network device, comprising in combination:
a radio frequency (RF) antenna;
a signal demodulator;
a voice decoder;
a signal modulator;
an optional voice encoder;
non-volatile storage;
a power generating circuit, wherein the power generating circuit includes a power harvesting circuit that provides power to the device by harvesting energy from other natural or artificial energy sources received on the RF antenna,
wherein the power harvesting circuit provides power to the device with the need for an internal power source;
a voice identification application stored in the non-volatile storage for uniquely identify an entity producing the voice signals received on the RF antenna,
wherein the voice signals received on the RF antenna to uniquely identify an entity sending voice signals to the device.

2. The passive voice enabled RFID network device of claim 1 wherein the radio frequency antenna includes a wireless personal area network (WPAN) antenna.

3. The passive voice enabled RFID network device of claim 1 wherein the accepts wireless signals, including: IEEE 802.11a, 802.11b, 802.11g, 802.11n, 802.15.4 (ZigBee), 802.16a, 802.16g, “Wireless Fidelity” (Wi-Fi), “Worldwide Interoperability for Microwave Access” (WiMAX), ETSI High Performance Radio Metropolitan Area Network (HIPERMAN) “RF Home,” Bluetooth or infra data association (IrDA) wireless signals.

4. The passive voice enabled RFID network device of claim 1 wherein the radio frequency antenna includes a baseband radio frequency transceiver.

5. The passive voice enabled RFID network device of claim 1 wherein the signal demodulator and signal modulator includes complementary code keying (CCK), differential binary phase shift keying (DBPSK), orthogonal frequency division multiplexing (OFDM) or Carrier Sense Multiple Access/Collision Avoidance (CSMA-CA).

6. The passive voice enabled RFID network device of claim 1 wherein the power harvesting circuit includes an N-level charge pump with pre-determined number diodes and a pre-determined number of capacitors in a pre-determined configuration, wherein the pre-determined number of diodes are connected on layers in series so that an output voltage is increased, wherein a voltage doubler circuit is included in each level, and wherein sets of two diodes are connected in series and oriented so that forward current flows from a ground potential to a positive terminal of an output voltage regulator and wherein one or more capacitor connected in parallel with a diode in each layer stores a resulting electrical charge to smooth the output voltage.

7. The passive voice enabled RFID network device of claim 1 wherein the N-level charge pump includes four levels with eight diodes and eight capacitors.

8. The passive voice enabled RFID network device of claim 1 wherein power generating circuit includes an impedance matching circuit, the power harvester circuit, a voltage regulator, a processor includes a fully programmable 16-bit microcontroller (MCU) with flash memory and one or more high-resolution analog-to-digital (ADC) converters.

9. The passive voice enabled RFID network device of claim 1 wherein the other natural or artificial sources include kinetic, thermal, gravitational, sound, light, chemical and electromagnetic energy sources.

10. The passive voice enabled RFID network device of claim 1 wherein the voice identification application provides speaker recognition based on voice information decoded by the voice decoder.

11. The passive voice enabled RFID network device of claim 1 wherein the entity is a human entity, animal entity or inanimate entity.

12. The passive voice enabled RFID network device of claim 1 wherein voice signals include human voice signals, non-human voice signals or other radio frequency sound signals.

13. The passive voice enabled RFID network device of claim 1 wherein the passive voice enabled RFID network device includes passive voice enabled RFID tags, passive voice enabled RFID sensors or passive voice enabled RFID biometric tags.

14. The passive voice enabled RFID network device of claim 1 wherein the passive voice enabled RFID network device includes a passive voice enabled RFID sensor, wherein the passive voice enabled RFID sensor includes Data, Information and Knowledge (DIaK) sensors or Integrated Systems Health Management (ISHM) sensors.

15. A method for using a passive voice enabled Radio Frequency Identifier (RFID) voice network device, comprising:
receiving voice information is received on the passive voice enabled RFID network device, wherein the voice information is used to generate power in a power generating circuit on the device as well as uniquely identify a pre-determined entity generating the voice information;
processing the voice information is processed on the passive voice enabled RFID network device via the voice decoder; and
identifying the pre-determined entity using the processed voice information, wherein the pre-determined entity may be a human or a non-human capable of producing distinct voice information or other distinct sounds.

16. A computer readable medium having stored therein instructions for one or more processors to execute the steps of the method of claim 15.

17. The method of claim 15 wherein the passive voice enabled Radio Frequency Identifier (RFID) voice network device comprises a radio frequency (RF) antenna; a signal demodulator; a voice decoder; a signal modulator; an optional voice encoder; non-volatile storage; a power generating circuit, wherein the power generating circuit includes a processor and a power harvesting circuit that provides power to the device by harvesting energy from voice signals or other natural or artificial energy sources received on the RF antenna, wherein the power harvesting circuit provides power to the device with the need for an internal power source; a voice identification application stored in the non-volatile storage for uniquely identify an entity producing the voice signals received on the RF antenna, wherein the voice signals received on the RF antenna are used to power the device and to uniquely identify an entity sending voice signals to the device.

18. A passive voice enabled radio frequency identifier (RFID) network device, comprising in combination:
receiving means for receiving radio frequency (RF) signals;
means for signal demodulation;
means voice decoding;
means for signal modulating;
an optional means for voice encoding;
means for non-volatile storage;
power generating means, wherein the power generating means includes a processor means and power harvesting circuit that provides power to the device by harvesting energy from other natural or artificial electromagnetic energy sources received on the receiving means;
wherein the power harvesting circuit provides power to the device without the need for an internal power source; and
a voice identification means stored in the non-volatile storage means uniquely identify an entity producing the voice signals received on the receiving means.

18. The passive voice enabled RFID network device of claim 17 wherein the power harvesting circuit includes an N-level charge pump with a number of pre-determined number diodes and a pre-determined number of capacitors, wherein the pre-determined number of diodes are connected on layers in series so that an output voltage is increased, wherein a voltage doubler circuit is included in each level, and wherein sets of two diodes are connected in series and oriented so that forward current flows from a ground potential to a positive terminal of an output voltage regulator and wherein one or more capacitor connected parallel with a diode in each layer stores a resulting electrical charge to smooth the output voltage.

19. The passive voice enabled RFID network device of claim 18 wherein the N-level charge pump includes four levels with eight diodes and eight capacitors.

20. The passive voice enabled RFID network device of claim 17 wherein the passive voice enabled RFID network device includes passive voice enabled RFID tags, passive voice enabled RFID sensors or passive voice enabled RFID biometric tags.
